(19) United States
(12) Patent Application Publication
(10) Pub. No.: US 2005/0067082 A1
(43) Pub. Date: Mar. 31, 2005

(54) Reduced manufacturing cost of gypsum board

(76) Inventor: Aaron P. Mowry, Duncan, OK (US)

Correspondence Address: Mr. Aaron P. Mowry, 4325 Ashland, Duncan, OK, 73533, US

(21) Appl. No.: 10/672,659

(22) Filed: Sep. 29, 2003

(51) Int. Cl. B32B 13/00

(52) U.S. Cl. 156/39; 423/555; 156/40; 156/41; 156/42; 156/43; 156/44; 156/45; 156/46

(57) ABSTRACT

Typically in modern gypsum board manufacturing plants, the gypsum slurry is separated into two slurries. One slurry containing more air in the form of foam, relatively low density gypsum, is used for the core of the board. The second slurry/slurries containing less air in the form of foam, relatively high density gypsum, is used for coating of the two paper sheets and along the long edges of the board. Other than the air content, the two slurries are same basic formulations. This patent covers the method of removing some or all of the starch from the relatively low density gypsum slurry for the core along with some of the water in this slurry. This starch, either dry or liquid, and water is then added to the relatively high density gypsum slurry/slurries that are used for the paper coatings and edges of the board. This puts the starch and water near the paper-core interface where it will maintain the bonding of the paper to the gypsum core. The water content of the two slurries will be less than is presently contained in the slurries with the existing manufacturing techniques. This reduce water content will reduce in less energy required to dry the gypsum board in the manufacturing process and therefore reduce the cost to manufacture gypsum board.

### BACKGROUND OF THE INVENTION

1. Field of the Invention

This invention relates to gypsum board and more specifically to the method to reducing the manufacturing cost of gypsum board through water reduction to the board core while maintaining paper to core bonding.

2. Description of Related Technology

Gypsum board is a commonly used material in the construction industry for residential and commercial properties. Gypsum board is made up of a gypsum core that is covered on both sides with paper sheets, a face and a back paper. The face paper is folded to wrap the gypsum board long edges and is overlapped by the back paper.

For many years to reduce the weight of gypsum board, air bubbles have been mixed into the gypsum core. This air is introduced into the core by a foaming agent added to the wet slurry.

Gypsum board made in this matter has two issues; soft or weak edges and poor bonding of the core to the two paper sheets. To address the issue of soft edges, gypsum slurry with less air is added to each long edge of the board during manufacturing. This lower air content gypsum slurry as been produced by not adding air in the form of foam to this slurry or by removing the air in the form of foam in this slurry by means of chemical and/or mechanical methods.

To improve the bonding of the core to the two paper sheets, starch is added to the gypsum slurry that is used for the core and edge slurries. The starch is moved in the gypsum board drying process by the water in the slurry to the paper-core interface to improve this bonding.

In recent years, this bonding has been further enhanced by coating the face and back papers with a coating of gypsum slurry with less air than the core gypsum. This lower air containing gypsum slurry can be achieved by not adding air in the form of foam to this slurry or by removing this air in the form of foam by chemical and/or mechanical methods. It has also been achieved by making two separate slurries from two separate mixers. Other than the amount of air present in the gypsum slurry used for the core and the gypsum slurry used for the coatings and edges, the two slurries are the same basic formulation.

It is the purpose of this invention to reduce the manufacturing cost of gypsum board by using different formulations of the core slurry and the coatings and edges slurry.

### SUMMARY OF THE INVENTION

In the modern process of manufacturing gypsum board, relatively high density gypsum slurry/slurries are used for coating the face and back paper sheets. This relatively high density gypsum slurry is achieved by either 1) not adding air in the form of foam or 2) by removing air in the form of foam from this slurry by chemical and/or mechanical methods.

Relatively low density gypsum slurry is used to produce the core of the gypsum board. This relatively low density gypsum slurry is achieved by adding air in the form of foam to the gypsum slurry.

This invention is to provide two different formulations for the coatings/edge slurry/slurries and core slurry. The starch will be reduced or eliminated in the core slurry and the water will be reduced to the core slurry. While additional starch (either dry or liquid) and water will be added to the coatings and edges slurry/slurries.

The higher water and starch content of the coatings and edges slurry/slurries will provide the necessary starch and water to immigrate this starch to the paper-core interface to provide for a satisfactorily paper core bond.

The amount of total water contained used in the gypsum board manufacturing process will be less than currently used by existing methods. This reduction in water content by this process will reduce the amount of water that must be removed in the drying area of the gypsum board manufacturing process. As a result, less energy will be required to remove this water in the drying process. Therefore, the cost to manufacture the gypsum board will be reduced.

### DETAILED DESCRIPTION OF THE INVENTION

Gypsum board is a very common material used in the construction industry for both residential and commercial properties. Typical gypsum board is ½ inch or ⅝ inch thick, but can range from ¼ inch to 1 inch. Typical gypsum board is 48 inch or 54 inch wide, with some specialty board be produced from 18 inch to 54 inch wide. Normally gypsum board is 8 feet to 16 feet long, but various lengths can be produced. Thickness, widths and lengths can be varied to meet customer requirements with the only limitations being the restrictions of each specific gypsum board manufacturing process.

Gypsum board is made up of a gypsum core with a paper face sheet and a paper back sheet. The paper face sheet is wider than the board and it folds around the board edge and is overlapped by the paper back sheet. The gypsum core is made up of primarily gypsum with some other raw materials to enhance the board performance or to control the process of gypsum board manufacturing.

To reduce the weight of the gypsum board, air in the form of foam is added to the gypsum core to displace part of the gypsum material and still maintain the dimensions of the gypsum board. This air containing gypsum is normally referred to as relatively low density gypsum. This relatively low density gypsum core results in weaker long edges of the board and has reduced bonding of the core to the two paper sheets.

Typically, starch is added to the gypsum slurry to improve the bonding of the gypsum core to the two paper sheets. The starch is mixed uniformly in to the gypsum slurry at the gypsum board mixer. The starch is carried by the water to the paper-core interface as the gypsum board is dried in the board dryer. Reducing the amount of water in the core, reduces the ability to move the starch to the paper-core interface resulting is poor bonds, especially humidified bonds.

To improve the weakness of the long edges, gypsum slurry that contains less air in the form of foam, relatively high density gypsum, is used to strengthen the gypsum board's long edge.
White U.S. Pat. No. 4,354,885 describes technique to generate relatively high density gypsum slurry for long board edges with a high speed mixer and retarders and water reducing agents.

It has also been determined that this relatively high density gypsum has better bonding to the paper than the relatively low density gypsum. It is the trend in gypsum manufacturing operations to take advantage of this improved bonding of the relatively high density gypsum to the paper sheets by coating the paper sheets with a thin layer of high density gypsum and filling the remainder of the core with relatively low density gypsum. There are several methods to apply the coatings as well as several methods to generate the relatively high density gypsum slurry and the relatively low density gypsum slurry.
Ainsley U.S. Pat. No. 5,908,521 describes technique to generate relatively high and relatively low density gypsum slurries by using two-stage mixer.
Chan U.S. Pat. No. 5,962,119 describes technique to coat the paper sheets with defoamer to create relatively high density gypsum for improved paper-core bonds.
Philips U.S. Pat. No. 5,879,486 describes technique to coat the paper sheets with relatively high density gypsum slurry using coater rolls/pressure rolls to improve the paper-core bonds.
Seecharan U.S. Pat. No. 6,190,476 describes technique to coat the paper sheets with relatively high density gypsum slurry using co-rotating spreader rolls to improve the paper-core bonds.
   Other than the content of air in the form of foam and some flush water, the formulations for the relatively high density gypsum and the relatively low density gypsum are identical.

With these various techniques, the gypsum board manufacturing process still relies on the water in the core carrying the starch to the paper-core interface as the board is dried in the gypsum dryer. The reduction of starch at this interface will result in lose of paper bonding to the core. Due to the dependents of this starch migration to the paper-core interfaces by the water in the core as it dries, a reduction in water in the core will also have a negative influence on the paper-core bondings.

This project covers the idea of using different formulations, other than air content, for the relatively high density gypsum and the relatively low density gypsum to reduce manufacturing cost of the gypsum board without negatively affecting the paper-core bonding of the board.

The starch will be reduced or eliminated in the relatively low density gypsum for the core. Water will also be reduced to this relatively low density gypsum slurry. The amount of water reduced to this relatively low density gypsum will be limited to the characteristics and properties of each specific gypsum material used as well as the other raw materials that are used to effect the fluidity of the relatively low density slurry. The amount of water reduced will also be limited by the arrangement and operating speed of each specific gypsum board manufacturing plant.

The starch, either dry or liquid form, will be added to the relatively high density gypsum slurry for used as paper coatings and board long edges. Depending on which method is used to produce the two slurries, relatively high density gypsum and relatively low density gypsum, some water may have to be added to the relatively high density slurry.

This method puts the starch closer to the paper-core interface where it is more beneficial for this bonding performance. This also reduces the reliance of moving the starch from the gypsum core by the water in the core. This will allow the amount of water in the core to be reduced without negatively affecting the paper-core bond.

The amount of water removed from the relatively low density gypsum slurry for the core will be more than the water added to the relatively high density gypsum slurry/slurries used for the paper coatings and long board edges. It is this difference in water amounts that will reduce the manufacturing cost of the gypsum board. Less water content in the gypsum board manufacturing process will reduce the energy required to dry the gypsum board.

1. Manufacturing cost of gypsum board can be reduced by using different formulations for core gypsum slurry (relatively low density) and coatings/edges gypsum slurry (relatively high density) by:
a. Reducing starch and water to the low density gypsum slurry used for the board core.
b. Adding starch (dry or liquid) and water to the high density gypsum slurry used for coatings and edges of the board.
c. Total water added to form the two different formulations of slurries will be less than presenting used by existing methods and techniques.
d. Energy cost to remove water from gypsum board in the manufacturing process will be reduced as a result of less total water being added in the manufacturing process.

2. The method of producing relatively high density gypsum slurry for the board coatings and edges by:
a. NOT adding foam
OR
b. in chemically or mechanically breaking down foam added to this slurry
Is not critical to this invention, only that two gypsum slurries are used to produce the gypsum board. One for the core of the board and the second for the paper sheets coatings and edges of the board.

3. The amount of water removed from the core gypsum slurry (relatively low density) will be dependent on:
a. Characteristics of each specific gypsum and stucco used in the gypsum board manufacturing.
b. General arrangement and speed of each specific gypsum board manufacturing process.

4. The amount of water added to the coatings/edges gypsum slurry (relatively high density) will dependent on:
a. Characteristics of each specific gypsum and stucco used in the gypsum board manufacturing.
b. General arrangement and speed of each specific gypsum board manufacturing process.
c. Coatings and edges equipment used.
